(19) United States
(12) Patent Application Publication
(10) Pub. No.: US 2011/0016158 A1
(43) Pub. Date: Jan. 20, 2011

(54) GENERATION OF DIMENSIONAL METADATA BASED ON RDBMS DATA

(76) Inventor: Gilles Robert Vergnory-Mion, Vaucresson (FR)

Correspondence Address: SAP AG c/o BUCKLEY, MASCHOFF & TALWALKAR LLC, 50 LOCUST AVENUE, NEW CANAAN, CT, 06840, US

(21) Appl. No.: 12/504,125

(22) Filed: Jul. 16, 2009

(51) Int. Cl. G06F 7/00

(52) U.S. Cl. 707/804; 707/E17.045

(57) ABSTRACT

Creation of a multi-dimensional metadata model based on relational tables and data stored in the relational tables may include determination of a plurality of groups of columns of the relational tables based at least in part on the data stored in the relational tables, where each column of a group of columns is mutually-dependent on each of the other columns of the group of columns, and where at least two of the plurality of groups of columns include columns of a same relational table. Also included may be creation of, for each of the plurality of groups of columns, a respective dimension object.

### CROSS REFERENCE TO RELATED APPLICATIONS

This application is related to commonly-assigned U.S. patent application Ser. No. 12/463,702, entitled “Functionally-Dependent Analysis Objects” and filed on May 11, 2009.

### BACKGROUND

Business data is typically stored within physical tables of a database. The database may comprise a relational database, such as Oracle, Microsoft SQL Server, IBM DB2, Teradata and the like. The structures and relationships of the physical database tables are complex. A typical end user is therefore unable to locate or extract desired information from the physical database tables.

Business Intelligence (BI) tools (e.g., BusinessObjects Universe Designer®) may be used to build an abstraction layer that shields end users from the complexity of the physical tables. More specifically, the abstraction layer allows the end users to query a database using intuitive terms rather than references to specific physical entities of the database.

U.S. Pat. No. 5,555,403 describes such an abstraction layer, referred to therein as a semantic layer. Briefly, a semantic layer defines a set of “business objects” that represent business entities, such as customers, time, financial figures, etc. Business objects may be classified as dimensions (along which one may want to perform an analysis or report), details (e.g., additional information on dimensions), and measures (e.g., indicators, most often numeric, whose value can be determined for a given combination of dimension values).

Dimension objects may be further abstracted into higher-level entities known as analysis objects. For example, the Country and City dimension objects may be child objects of a Geography analysis object, and a Product dimension object may be a child object of a Production analysis object. A dimension object may be referenced through its parent analysis object.

A user of a BI tool may use analysis objects of an abstraction layer to query underlying physical tables. For example, the user may formulate a symbolic query using the business objects of the abstraction layer. A query generator may then generate a query of an underlying database based on the symbolic query and on a mapping between the tables of the database and the abstraction layer.

Creation of an abstraction layer based on a relational database is time-consuming and costly. Commonly-assigned U.S. Pat. No. 7,181,440 describes a system to generate a dimensional data model based on a relational database. Although this system provides significant advantages over prior systems, systems are desired which may provide more-refined data models and/or greater efficiency.

### BRIEF DESCRIPTION OF THE DRAWINGS

FIG. 1 is a block diagram of a system.

FIG. 2 is a representation of a relational database.

FIG. 3 is a flow diagram of a process to generate dimensional metadata according to some embodiments.

FIG. 4 is a diagram illustrating groups of database table columns according to some embodiments.

FIG. 5 is a diagram illustrating groups of database table columns and one way dependencies therebetween according to some embodiments.

FIG. 6 is a representation of an abstraction layer corresponding to the FIG. 2 database tables according to some embodiments.

FIG. 7 is a UML class diagram of the FIG. 6 abstraction layer according to some embodiments.

FIG. 8 is a representation of a system including dimensional metadata generated according to some embodiments.

### DETAILED DESCRIPTION

The following description is provided to enable any person in the art to make and use the described embodiments and sets forth the best mode contemplated for carrying out some embodiments. Various modifications, however, will remain readily apparent to those in the art.

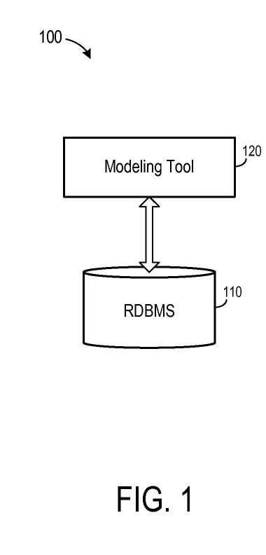

Embodiments may be implemented by an architecture such as system 100 of FIG. 1. Relational database management system (RDBMS) 110 may comprise any query-responsive data source or sources of relational data that are or become known, including but not limited to a relational database management system.

Modeling tool 120 may comprise a software application to retrieve a table structure and data from RDBMS 110 as described below. Modeling tool 120 may communicate with RDBMS 110 via any suitable database connections (e.g., Java Database Connector, QT/Connection Server). In some embodiments, modeling tool 120 comprises BusinessObjects Universe Designer® or BusinessObjects BI Modeler®.

Modeling tool 120 may operate to determine a plurality of groups of columns of relational tables of RDBMS 110 based at least in part on data stored in the relational tables. Each column of a group of columns is mutually-dependent on each of the other columns of the group of columns, and at least two of the plurality of groups of columns include columns of a same relational table. Moreover, modeling tool 120 may create, for each of the plurality of groups of columns, a respective dimension object.

Some embodiments may therefore efficiently provide more than one dimension object per relational table, resulting in a potentially more-expressive abstraction layer than previously available. Since the groups of columns are determined based at least in part on data stored in the relational tables, the underlying schema of RDBMS 110 need not be fully normalized prior to generation of the dimension objects according to some embodiments.

The elements of system 100 may be implemented by any suitable combination of hardware and/or software. Each element may be located remotely from one or more other elements. More than one element may be implemented in a single device and/or software package.

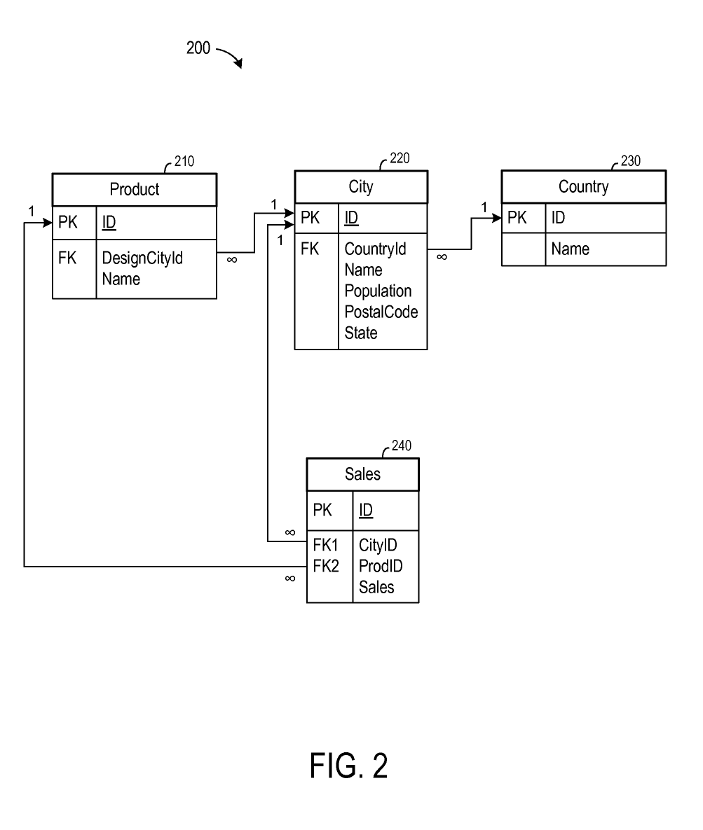

FIG. 2 illustrates schema 200 of a data source of relational tables for purposes of example. As shown, Product table 210 includes a foreign key DesignCityId to City table 220, and City table 220 includes a foreign key CountryId to Country table 230. Also shown is Sales table 240, including a foreign key ProdId to Product table 210 and a foreign key CityID to City table 220. In addition to the above-described foreign keys, each table of schema 200 includes one or more additional columns.

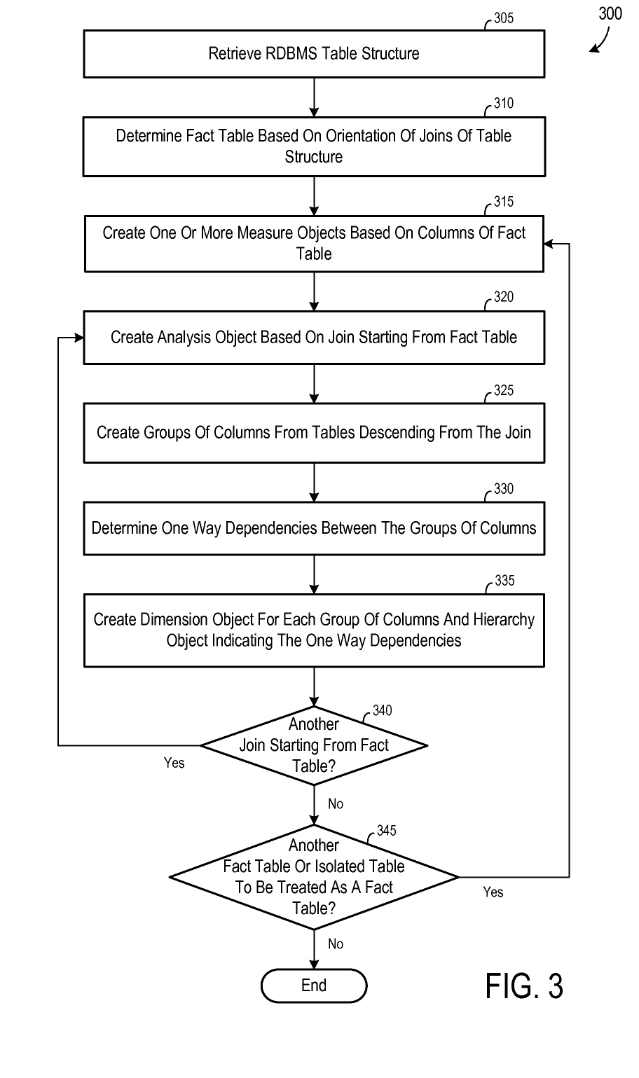

FIG. 3 is a flow diagram of process 300 according to some embodiments. Process 300 may be implemented by modeling tool 120 but embodiments are not limited thereto. In this regard, process 300 may be embodied in computer-executable program code stored on a tangible computer-readable medium. Process 300 may be implemented by any combination of hardware and/or software.

Initially, at 305, a table structure of an RDBMS is retrieved. The retrieved structure may include a list of tables, their constituent columns, and joins therebetween. Such a structure may be referred to as a data foundation, systems for retrieval of which are known in the art.

At 310, a fact table is determined based on the orientation of the joins of the table structure. For example, a table of the table structure is identified as a fact table based on the cardinalities of its joins to other tables (e.g., ∞ to 1). In the example of FIG. 2, Sales table 240 is determined to be a fact table because of the cardinalities of its joins to Product table 210 and to City table 220.

One or more measure objects are created at 315 based on the columns of the determined fact table. In some embodiments, one measure object is created to correspond to each numeric non-key column of the fact table. In the illustrated example, a Sales measure object is created at 315 to correspond to the Sales column of Sales table 240. The measure object may also indicate the dimension object(s) (described below) which drives the column corresponding to the measure object.

An analysis object is created at 320 based on a join which starts from the current fact table. The analysis object is created in metadata that may be used in an abstraction layer according to some embodiments. Continuing with the present example, a Production analysis object may be created at 320 based on the join between Sales fact table 240 and Product table 210. Next, at 325, groups of columns are created from the tables descending from the above-mentioned join. With respect to the present example, the descending tables are Product table 210, City table 220 (by virtue of the join between Product table 210 and City table 220), and Country table 230 (by virtue of the join between City table 220 and Country table 230).

Groups of columns may be created from these tables based on the table structure and on the data stored in the columns. According to some examples of 325, each created group of columns includes only mutually-dependent columns. Accordingly, 325 may comprise retrieving and analyzing data stored within all the columns of the descending tables to identify any mutual dependencies therebetween.

For example, the data of City table 220 may be retrieved and analyzed to identify mutual dependencies between columns Name, Population and Postal Code. Accordingly, a group may be created at 325 including columns Name, Population and Postal Code of City table 220.

The data of City table 220 may be further analyzed to determine that no mutual dependencies exist with respect to column State. A group may therefore also be created at 325 including column state of City table 220.

According to some embodiments, only one query is issued per table when retrieving data at 325, in order to reduce processing time. The one query may scan all columns of the table without using any joins, ordering, grouping or filtering. Additionally or alternatively, detection of dependencies may occur while rows of data are being fetched and such fetching may terminate once all dependencies (or lack thereof) are believed to have been identified. Some embodiments cap the number of rows fetched, and/or skip over partially-empty rows or null data values.

Primary/foreign key information of the RDBMS may also be used at 325 to infer dependencies between columns of a single table. For example, if a primary key exists in a table, it is assumed that one way dependencies exist between the columns of the primary key and the column(s) of the foreign key. It may also be assumed that no dependencies exist between foreign keys inside a same table, without regard to the actual data of the foreign key columns.

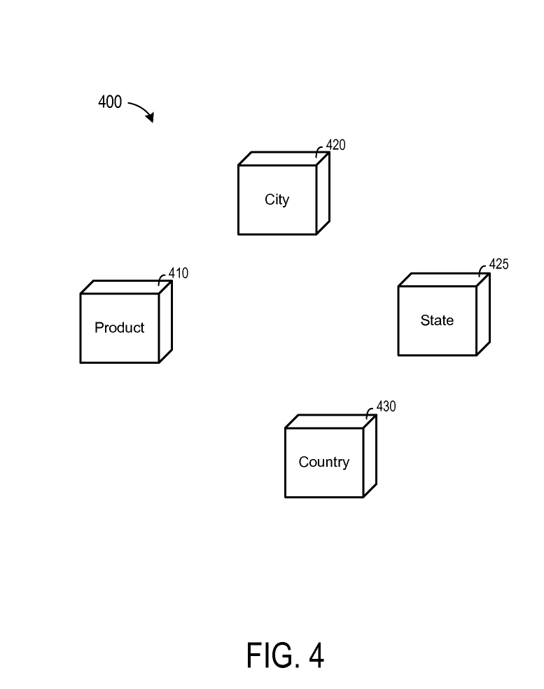

FIG. 4 illustrates groups of columns 400 created at 325 based on schema 200 according to some embodiments. Groups 410 and 430 correspond to tables 210 and 230, respectively, and include each column of their respective table. However, both of groups 420 and 425 include columns of City table 220. Group 420 includes columns Name, Population and Postal Code due to mutual dependencies identified between the data of these columns, while group 425 includes column State because no mutual dependencies were identified with respect to this column.

One way dependencies between columns of the different groups are determined at 330. These dependencies may be determined from the retrieved table structure (i.e., the list of tables and joins) as well as the data content. For example, if the structure indicates a link between a Product table and a Product Category table, the link is analyzed to deduce a dependency between product and product category columns. A direction of the dependency between two groups (i.e., between one column of one group and one column of another group) may be determined based on table key information and cardinality information detected from the data of the linked columns.

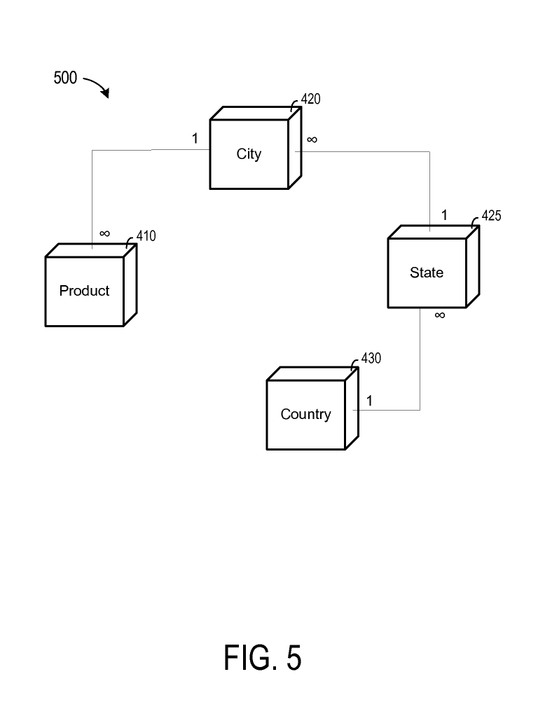

FIG. 5 illustrates the groups of FIG. 4 and the one way dependencies determined therebetween according to some embodiments. According to some embodiments of 330, a single group of columns may be created from two groups of columns which are connected by a dependency, if their cardinalities are sufficiently close and no other key information forbids combination of the groups of columns (as described above). For example, columns of a group including column Customer Full Name may be merged with columns of a group including column Customer Social Security Number into a single group even if the data of the columns includes two customers with identical names and different Social Security Numbers.

Next, at 335, a dimension object is created for each group of columns. Also, a hierarchy object indicating the determined one way dependencies is associated with the analysis object created at 320.

A dimension object may be created in metadata of the aforementioned abstraction layer. The dimension object may be created based on a group of columns by choosing one column of the group as the name of the dimension object and assigning the other columns as properties of the object. Foreign key columns may be designated as “outgoing” properties, which will be described in detail below.

The analysis object is linked to the hierarchy object specifying the determined one way dependencies. The analysis object is associated to a key column thru the dimension objects that describe it, and thereby indicates the set of all the dimension objects describing data that depends directly or indirectly to that key column. In the present example, the Production analysis object is associated to the Product key column.

Tree 600 illustrates metadata of an abstraction layer based on schema 200. Tree 600 includes the above-described dimension objects corresponding to the Sales, City, State and Country groups of columns, as well as the Production analysis object. As described in commonly-assigned U.S. patent application Ser. No. 12/463,702, tree 600 includes metadata of properties associating a dimension object with one or more other dimension objects. These properties represent the one way dependencies shown in FIG. 5.

Tree 600 also includes the Sales measure object created at 325. The Sales measure object indicates the dimension objects (Product, City) that drive the data thereof. Creation of the remaining objects of tree 600 will be described below.

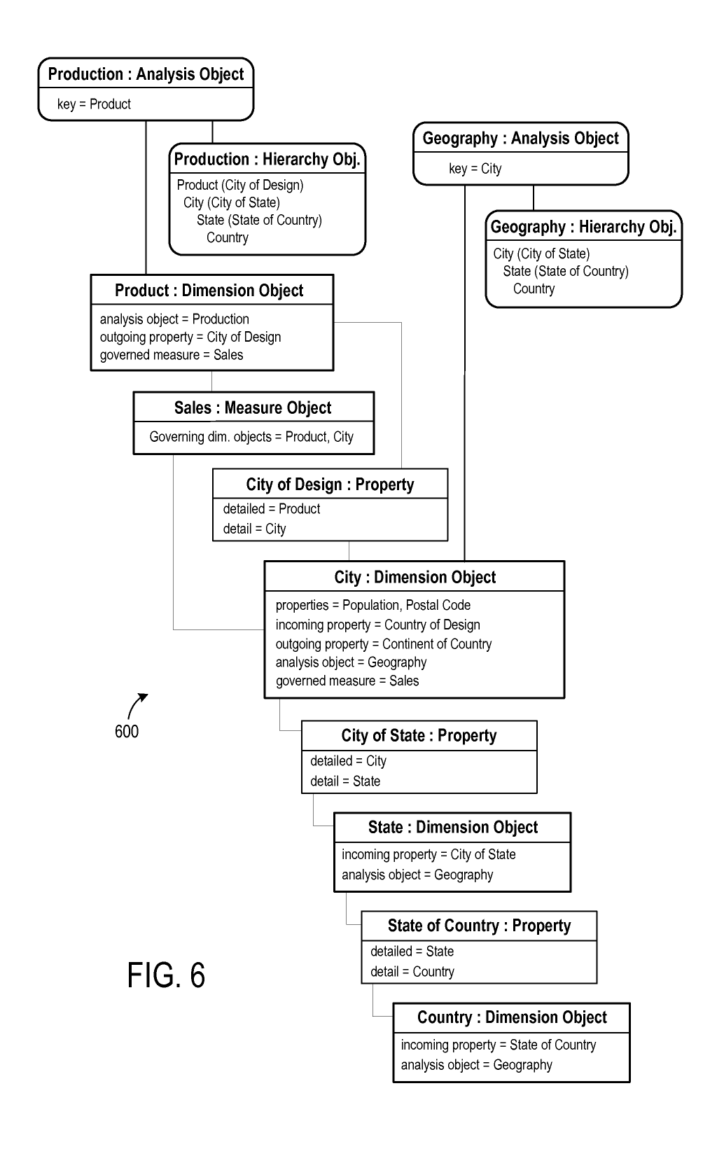

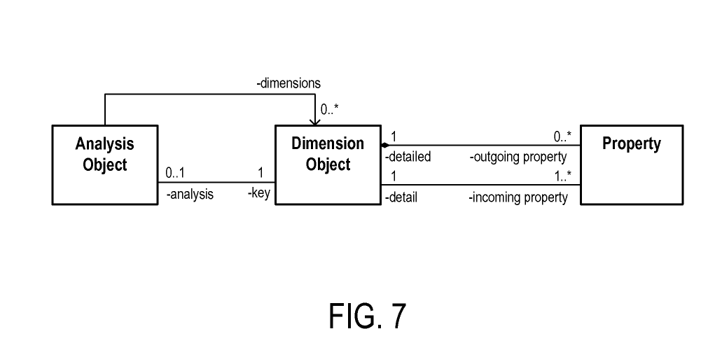

FIG. 7 is a UML class diagram of an analysis object, a dimension object and an associated property according to some embodiments such as illustrated in FIG. 6. As shown, an analysis object references a dimension object of a functional dependency tree. Conversely, the dimension object is the key of the analysis object. The analysis object is able to provide all the dimension objects to which it is indirectly linked by traversing the dimension objects and properties of the functional dependency tree. The dimension object is a named atomic entity for semantic definition and query specification, and the property is a named atomic entity for defining a many-to-one or a one-to-one relationship between two dimension objects.

Returning to process 300, flow proceeds to 340 and returns to 315 if another join exists which starts from the present fact table. If so, a new analysis object is created along with associated dimension objects as described above. However, no dimension object is created for a group of columns associated with the new analysis object if a dimension object has already been created for that group of columns for another analysis object. Nevertheless, the previously-created dimension object will be reflected in the hierarchy of the newly-created analysis object. For example, using the FIG. 2 structure, a second analysis object (e.g., Geography) is created upon return to 320 based on the join from Sales fact table 240 to City table 220, groups of columns are determined based on City table 220 and Country table 230 at 325, but no dimension objects are created at 335 based on the groups because these objects have already been created. These already-created objects are specified in the hierarchy object linked to the Geography analysis object, as shown in FIG. 6.

If no other joins are determined to start from the fact table, flow proceeds from 340 to 345 to determine whether another fact table (or an isolated table that is not joined to another table) exists. If so, flow returns to 315 and continues as described above with respect to the fact table (or isolated table). Flow terminates once the determination at 345 is negative.

It is noted that the Production and Geography analysis objects of tree 600 are functionally-dependent. Moreover, the Sales measure object is governed by the Product and City dimension objects of the Production and Geography analysis objects. The metadata of tree 600 may be leveraged to issue a dimension object-based query such as “select the sales amount of products in their design country”. The functional dependencies may also or alternatively be leveraged to issue an analysis object-based query such as “select the sales amount of products in their design geography”.

Embodiments may be employed to efficiently define a semantically rich abstraction layer on a relational data source. Since the functional dependencies between dimension objects enable navigation from one analysis object to another, the dimension objects may be used explicitly when a query is expressed in terms of dimension objects, or implicitly when the query is expressed in terms of analysis objects.

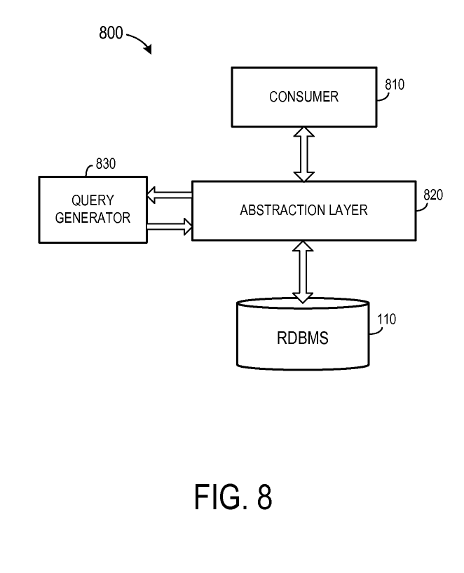

Referring to FIG. 8, consumer 810, which may comprise a reporting tool or any other system requiring access to the data of RDBMS 110, views and interacts with the metadata of abstraction layer 820, which may comprise dimensional metadata such as tree 600 generated according to some embodiments. For example, consumer 810 may formulate a symbolic query using the objects of abstraction layer 820. Query generator 830 may then generate a query of RDBMS 110 based on the symbolic query. Commonly-assigned, co-pending U.S. patent application Ser. No. 12/463,757 provides detailed examples of query generation based on a symbolic query that may be suitable for use in conjunction with an abstraction layer generated as described herein.

Embodiments described herein are solely for the purpose of illustration. Those in the art will recognize other embodiments may be practiced with modifications and alterations to that described above.

What is claimed is:

1. A method of creating a multi-dimensional metadata model based on relational tables and data stored in the relational tables, comprising:
determining a plurality of groups of columns of the relational tables based at least in part on the data stored in the relational tables, where each column of a group of columns is mutually-dependent on each of the other columns of the group of columns, and where at least two of the plurality of groups of columns include columns of a same relational table; and
creating, for each of the plurality of groups of columns, a respective dimension object.

2. A method according to claim 1, wherein the relational tables descend from a join starting from a fact table, the method further comprising:
creating an analysis object associated with the relational tables and the join;
determining a plurality of one way dependencies between the created dimension objects;
determining a hierarchy of the created dimension objects based on the determined one way dependencies; and
associating the hierarchy with the analysis object.

3. A method according to claim 2, wherein the analysis object indicates a respective dimension object associated with each of the second plurality of groups of columns and the one or more of the determined one way dependencies.

4. A method according to claim 1, wherein creating a respective dimension object for a group of columns comprises:
selecting one of the groups of columns to represent a name of the respective dimension object; and
assigning each other column of the group of columns to a property of the respective dimension object.

5. A method according to claim 1, further comprising:
determining the fact table based on an orientation of joins associated with the relational tables; and
creating one or more measure objects based on the fact table.

6. A method according to claim 5, further comprising:
associating one or more dimension objects with each of the one or more measure objects.

7. A method according to claim 6, wherein the relational tables descend from a join starting from the fact table, the method further comprising:
creating an analysis object associated with the relational tables and the join;
determining a plurality of one way dependencies between the created dimension objects;
determining a hierarchy of the created dimension objects based on the determined one way dependencies; and
associating the hierarchy with the analysis object.

8. A method according to claim 7, wherein the analysis object indicates a respective dimension object associated with each of the second plurality of groups of columns and the one or more of the determined one way dependencies.

9. A method according to claim 6, wherein creating a respective dimension object for a group of columns comprises:
selecting one of the groups of columns to represent a name of the respective dimension object; and
assigning each other column of the group of columns to a property of the respective dimension object.

10. A tangible computer-readable medium having stored thereon program code, the program code executable by a computer to:
determine a plurality of groups of columns of relational tables based at least in part on data stored in the relational tables, where each column of a group of columns is mutually-dependent on each of the other columns of the group of columns, and where at least two of the plurality of groups of columns include columns of a same relational table; and
create, for each of the plurality of groups of columns, a respective dimension object.

11. A medium according to claim 10, wherein the relational tables descend from a join starting from a fact table, the program code further executable by a computer to:
create an analysis object associated with the relational tables and the join;
determine a plurality of one way dependencies between the created dimension objects;
determine a hierarchy of the created dimension objects based on the determined one way dependencies; and
associate the hierarchy with the analysis object.

12. A medium according to claim 11, wherein the analysis object indicates a respective dimension object associated with each of the second plurality of groups of columns and the one or more of the determined one way dependencies.

13. A medium according to claim 10, wherein the program code executable by a computer to create a respective dimension object for a group of columns comprises program code executable by a computer to:
select one of the groups of columns to represent a name of the respective dimension object; and
assign each other column of the group of columns to a property of the respective dimension object.

14. A medium according to claim 10, the program code further executable by a computer to:
determine the fact table based on an orientation of joins associated with the relational tables; and
create one or more measure objects based on the fact table.

15. A medium according to claim 14, the program code further executable by a computer to:
associate one or more dimension objects with each of the one or more measure objects.

16. A medium according to claim 15, wherein the relational tables descend from a join starting from the fact table, the program code further executable by a computer to:
create an analysis object associated with the relational tables and the join;
determine a plurality of one way dependencies between the created dimension objects;
determine a hierarchy of the created dimension objects based on the determined one way dependencies; and
associate the hierarchy with the analysis object.

17. A medium according to claim 16, wherein the analysis object indicates a respective dimension object associated with each of the second plurality of groups of columns and the one or more of the determined one way dependencies.

18. A medium according to claim 15, wherein the program code executable by a computer to create a respective dimension object for a group of columns comprises program code executable by a computer to:
select one of the groups of columns to represent a name of the respective dimension object; and
assign each other column of the group of columns to a property of the respective dimension object.

19. A system comprising:
a database of relational tables and data stored in the relational tables; and
a modeling tool to:
determine a plurality of groups of columns of relational tables based at least in part on data stored in the relational tables, where each column of a group of columns is mutually-dependent on each of the other columns of the group of columns, and where at least two of the plurality of groups of columns include columns of a same relational table; and
create, for each of the plurality of groups of columns, a respective dimension object.

20. A system according to claim 19, wherein the relational tables descend from a join starting from a fact table, the modeling tool further to:
create an analysis object associated with the relational tables and the join;
determine a plurality of one way dependencies between the created dimension objects;
determine a hierarchy of the created dimension objects based on the determined one way dependencies; and
associate the hierarchy with the analysis object.

21. A system according to claim 19, wherein creation of a respective dimension object for a group of columns comprises:
selection of one of the groups of columns to represent a name of the respective dimension object; and
assignment of each other column of the group of columns to a property of the respective dimension object.
